(19) United States
(12) Patent Application Publication
(10) Pub. No.: US 2025/0045195 A1
(43) Pub. Date: Feb. 6, 2025

(54) RECORDING MEDIUM, DEBUGGING ASSISTANCE DEVICE, AND DEBUGGING ASSISTANCE METHOD

(71) Applicant: Mitsubishi Electric Corporation, Tokyo (JP)

(72) Inventor: Kakeru YOKOI, Tokyo (JP)

(73) Assignee: Mitsubishi Electric Corporation, Tokyo (JP)

(21) Appl. No.: 18/718,803

(22) PCT Filed: Feb. 18, 2022
(86) PCT No.: PCT/JP2022/006757

§ 371 Date: Jun. 12, 2024

(51) Int. Cl. G06F 11/36

(52) U.S. Cl. CPC G06F 11/3664

(57) ABSTRACT

A debugging assistance program causes a computer to function as a sequence program identification information receiver that receives an input of sequence program identification information for identifying a sequence program, an acquirer that acquires, from a programmable logic controller on which the sequence program identified with the sequence program identification information has been executed, a value of a label included in the sequence program identified with the sequence program identification information, and a display that displays the acquired value of the label in a bit string with a bit width assigned to the label corresponding to the acquired value.

### TECHNICAL FIELD

The present disclosure relates to a debugging assistance program, a debugging assistance device, and a debugging assistance method.

### BACKGROUND ART

Techniques are known for debugging a sequence program executed by a programmable logic controller (PLC) by displaying values of labels included in the sequence program and representing, for example, data in an input-output (I/O) device and data in a work memory. Patent Literature 1 describes, for example, a technique for an operation result transmission program activated by a sequence program executed by a PLC to transmit state information about an I/O device to a monitor device that displays the state information about the I/O device in bits.

### CITATION LIST

### Patent Literature

Patent Literature 1: Unexamined Japanese Patent Application Publication No. 2003-122405

### SUMMARY OF INVENTION

### Technical Problem

With the technique described in Patent Literature 1 above, the bit width of a bit string representing the state information about the I/O device is fixed. However, the bit width assigned to a label in the sequence program changes based on information associated with the label. For displaying a value of a label, a user using the above technique is required to specify the bit width assigned to the label to be displayed.

Under such circumstances, an objective of the present disclosure is to provide a debugging assistance program, a debugging assistance device, and a debugging assistance method for displaying a value of a label in a sequence program in a bit string with a bit width assigned to the label.

### Solution to Problem

To achieve the above objective, a debugging assistance program according to an aspect of the present disclosure causes a computer to function as sequence program identification information receiving means for receiving an input of sequence program identification information for identifying a sequence program, acquisition means for acquiring, from a programmable logic controller on which the sequence program identified with the sequence program identification information has been executed, a value of a label included in the sequence program identified with the sequence program identification information, and display means for displaying the acquired value of the label in a bit string with a bit width assigned to the label corresponding to the acquired value.

### Advantageous Effects of Invention

The debugging assistance program, the debugging assistance device, and the debugging assistance method according to the above aspect of the present disclosure can display a value of a label in a sequence program in a bit string with a bit width assigned to the label.

### BRIEF DESCRIPTION OF DRAWINGS

FIG. 1 is a functional block diagram of a debugging assistance device according to an embodiment;

FIG. 2 is a block diagram of the debugging assistance device according to the embodiment, illustrating the hardware configuration;

FIG. 3 is a diagram of an example label value display window in the embodiment;

FIG. 4 is a diagram of values of labels in a sequence program in the embodiment being displayed;

FIG. 5 is a diagram of values of labels included in a structure in the embodiment being displayed;

FIG. 6 is a diagram of values of labels included in an instance of a function block in the embodiment being displayed;

FIG. 7 is a diagram of values of labels that has undergone filtering according to the embodiment being displayed;

FIG. 8 is a diagram of a value of a label in the embodiment after being changed;

FIG. 9 is a diagram of values of labels included in an instance generated from a specified function block in the embodiment being displayed; and

FIG. 10 is a flowchart of a display process in the embodiment.

### DESCRIPTION OF EMBODIMENTS

### Embodiments

A debugging assistance device 100 according to an embodiment assists in debugging a sequence program executed by a programmable logic controller (PLC) 200. The debugging assistance device 100 is connected to the PLC 200 wirelessly or with a network cable (not illustrated) for mutual communication.

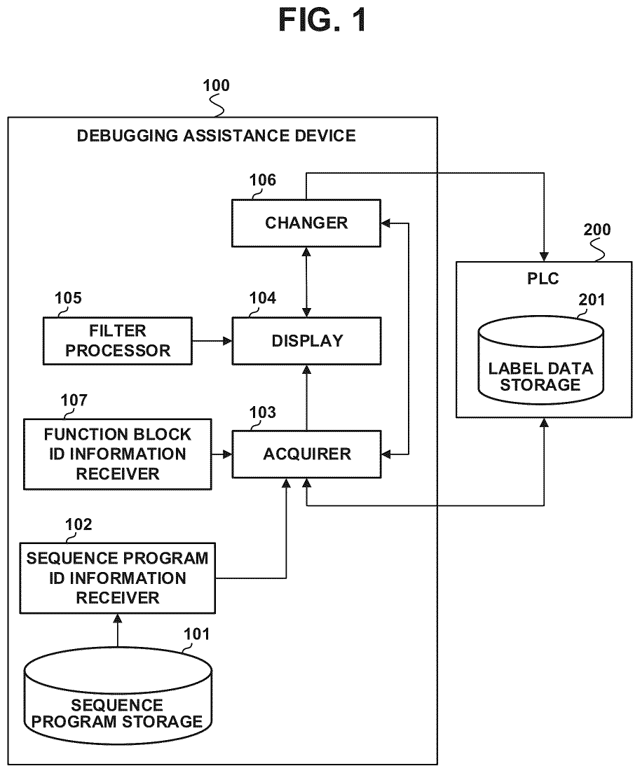

FIG. 1 is a functional block diagram of the debugging assistance device 100. The debugging assistance device 100 includes, as functional components, a sequence program storage 101 that stores a sequence program, a sequence program identification (ID) information receiver 102 that receives an input of sequence program ID information, an acquirer 103 that acquires values of labels included in the sequence program identified with the sequence program ID information, a display 104 that displays the acquired values of labels in bit strings, a filter processor 105 that filters labels displayed by the display 104 using character strings included in a label name, a changer 106 that changes values of bit strings based on a change operation, and a function block identification (ID) information receiver 107 that receives an input of function block ID information.

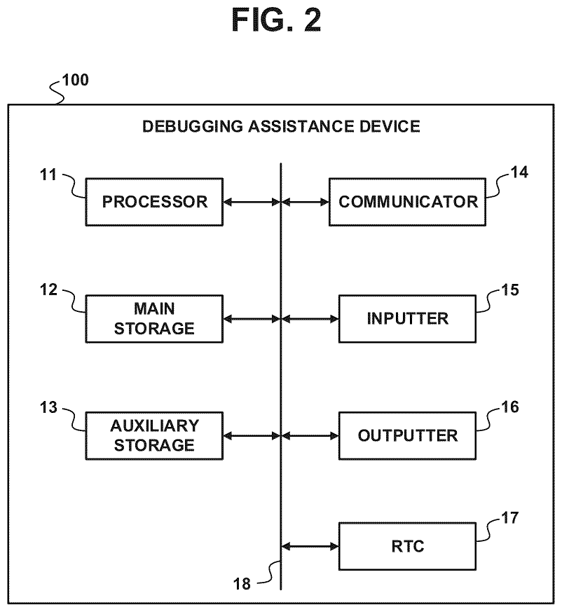

The debugging assistance device 100 in FIG. 1 has the hardware configuration illustrated in FIG. 2.

The debugging assistance device 100 includes a processor 11 that performs various types of processing, a main storage 12 used as a work area by the processor 11, an auxiliary storage 13 that stores various data items used for processing performed by the processor 11, a communicator 14 that communicates with an external device, an inputter 15 that acquires input information, an outputter 16 that presents various items of information, and a real time clock (RTC) 17 that measures time. The main storage 12, the auxiliary storage 13, the communicator 14, the inputter 15, the outputter 16, and the RTC 17 are connected to the processor 11 with a bus 18.

The processor 11 includes a central processing unit (CPU). The processor 11 executes programs stored in the auxiliary storage 13 to implement various functions of the debugging assistance device 100.

The main storage 12 includes a random-access memory (RAM). The programs are loaded from the auxiliary storage 13 into the main storage 12. The main storage 12 is used as a work area by the processor 11.

The auxiliary storage 13 includes a nonvolatile memory, such as an electrically erasable programmable read-only memory (EEPROM). The auxiliary storage 13 stores, in addition to the programs, various data items used for processing performed by the processor 11. The auxiliary storage 13 provides data usable by the processor 11 to the processor 11 as instructed by the processor 11, and stores data provided by the processor 11.

The communicator 14 includes a network interface circuit for communicating with an external device. The communicator 14 receives a signal from the external device and outputs data represented by the signal to the processor 11. The communicator 14 also transmits a signal representing data output from the processor 11 to the external device.

The inputter 15 includes input devices such as input keys and a pointing device. The inputter 15 acquires information input by the user of the debugging assistance device 100, and provides the acquired information to the processor 11.

The outputter 16 includes output devices such as a liquid crystal display (LCD) and a speaker. The outputter 16 may include a touchscreen integral with the pointing device included in the inputter 15. The outputter 16 presents various items of information to the user as instructed by the processor 11.

The RTC 17 is a clocking device including an oscillator circuit using a crystal oscillator. The RTC 17 includes, for example, a built-in battery. The RTC 17 continues to measure time after the debugging assistance device 100 is powered off.

The sequence program storage 101 in FIG. 1 stores a sequence program executable by the PLC 200. The sequence program storage 101 is implemented by the auxiliary storage 13.

The debugging assistance device 100 includes a function to display values of labels included in the sequence program stored in the sequence program storage 101 on a screen.

A label is an element included in the sequence program and indicates variables used in the sequence program. The label is associated with, for example, data in an input-output (I/O) device connected to the PLC 200 and data in a work memory used to execute the sequence program in the PLC 200.

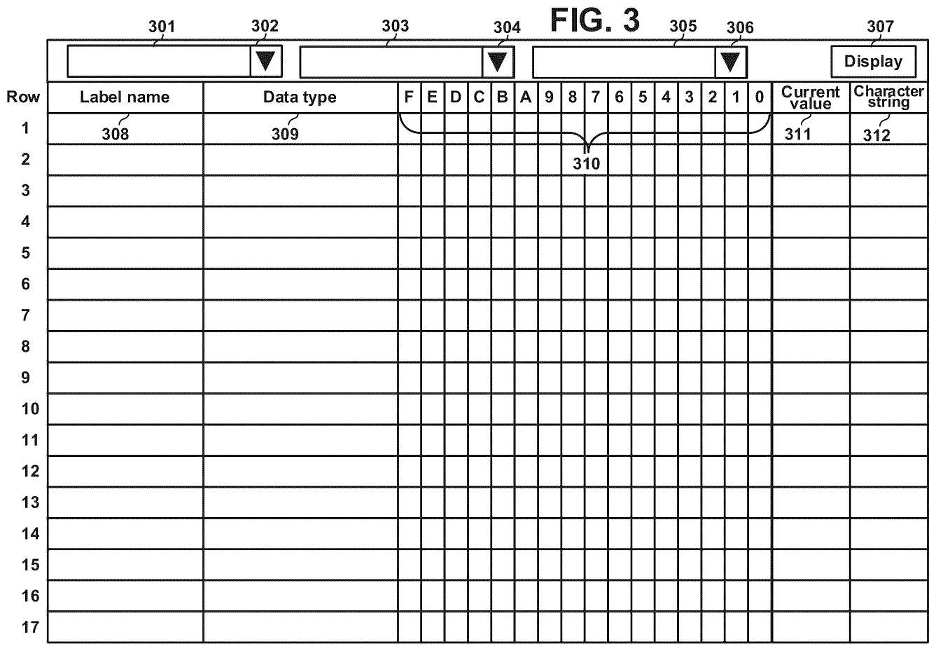

When the user performs an operation to activate an application for displaying the values of labels included in the sequence program in the debugging assistance device 100, a label value display window illustrated in FIG. 3 appears on the screen of the debugging assistance device 100. The application for displaying the values of labels included in the sequence program is hereafter referred to as a label value display application.

The label value display window in FIG. 3 includes a field 301 used to input a sequence program name, a pulldown button 302 that lists sequence programs in the sequence program storage 101, a field 303 used to input a character string included in a label name, a pulldown button 304 that lists character strings input in the past into the field 303, a field 305 used to input the name of a function block, a pulldown button 306 that lists function blocks used in the sequence programs included in the sequence program storage 101, and a display button 307 that displays the values of labels based on the entries in the fields 301, 303, and 305.

The label value display window in FIG. 3 also includes a table including, in a manner associated with one another, an item 308 for the name of the label included in the sequence program, an item 309 for the data type of the label, an item 310 for the bit string representing current values of the label, an item 311 for the current value of the label, and an item 312 for the character string stored in the label.

The debugging assistance device 100 enables communication with the PLC 200 when the label value display application is activated. The acquirer 103 enables, for example, communication between the debugging assistance device 100 and the PLC 200. With the communication being enabled, the debugging assistance device 100 can refer to label data stored in a label data storage 201 in the PLC 200. The label data stored in the label data storage 201 is the data associated with labels included in the sequence program, and includes, for example, data in the I/O device connected to the PLC 200 and data in the work memory used to execute the sequence program in the PLC 200.

The sequence program ID information receiver 102 in FIG. 1 receives an input of sequence program ID information for identifying the sequence program. The sequence program ID information receiver 102 is implemented by the processor 11 and the inputter 15. The sequence program ID information receiver 102 is an example of sequence program identification information receiving means.

The sequence program ID information is used for identifying the sequence program stored in the sequence program storage 101 and is, for example, the name of the sequence program.

When, for example, the user inputs “a sequence program A” that is the name of the sequence program into the field 301 in the label value display window and presses the display button 307, the sequence program ID information receiver 102 receives an input of sequence program ID information about “the sequence program A”.

The acquirer 103 in FIG. 1 acquires a value of a label included in the sequence program identified with the sequence program ID information from the PLC 200 on which the sequence program identified with the sequence program ID information has been executed. The acquirer 103 is implemented by the processor 11 and the communicator 14. The acquirer 103 is an example of acquisition means.

For example, the acquirer 103 specifies labels included in “the sequence program A” and acquires label data associated with the specified labels from the label data storage 201 in the PLC 200. The label data to be acquired includes the current value of the label and a bit string representing the current value of the label. When the data type of the label allows a character string to be stored, the label data to be acquired also includes the character string stored in the label.

The sequence program identified with sequence program ID information includes a plurality of labels. The acquirer 103 thus acquires values of the plurality of labels included in the sequence program identified with the sequence program ID information. The plurality of labels may include a label included in an instance generated from a function block or a label included in a structure.

The acquirer 103 acquires, for example, label data of labels with label names “wLabel”, “dLabel”, “wArray”, “bArray”, “stLabel”, and “Instance_FB_A_1”, the labels being included in “the sequence program A”.

A label with the label name “wLabel” is assigned with a bit width of 16 bits. A label with the label name “dLabel” is assigned with a bit width of 32 bits. Each of labels with the label names “wArray” and “bArray” indicates a sequence. A label with the label name “wArray” is assigned with a bit width of 16 bits and associated with data about a sequence of a 16-bit string×4. A label with the label name “bArray” is assigned with a bit width of 18 bits and associated with data about a sequence of an 18-bit string×1.

A label with the label name “stLabel” indicates a structure. A structure label includes one or more labels. The label with the label name “stLabel” includes the labels with the label names “uLabel1”, “uLabel2”, “uLabel3”, “bLabel1”, and “sLabel1”. Labels with the label names “uLabel1”, “bLabel1”, “sLabel1”, and “uLabel3” are assigned with a bit width of 16 bits. A label with the label name “uLabel2” is assigned with a bit width of 32 bits.

The label with the label name “Instance_FB_A_1” indicates an instance generated from a function block “FB_A”. An instance generated from a function block is hereafter simply referred to as an instance. An instance label includes one or more labels. The label with the label name “Instance_FB_A_1” includes the labels with the label names “vLabel1”, “vLabel2”, “vLabel3”, “cLabel1”, and “tLabel1”. Labels with the label names “vLabel1”, “vLabel2”, “vLabel3”, and “cLabel1” are assigned with a bit width of 16 bits. A label with the label name “tLabel1” is assigned with a bit width of 32 bits.

The display 104 in FIG. 1 displays the acquired value of the label in a bit string with a bit width assigned to the label corresponding to the acquired value. The display 104 displays, when values of the plurality of labels are acquired by the acquirer 103, each of the acquired values of the plurality of labels in a bit string with a bit width assigned to each of the plurality of labels corresponding to the acquired values. The display 104 is implemented by the processor 11 and the outputter 16. The display 104 is an example of display means.

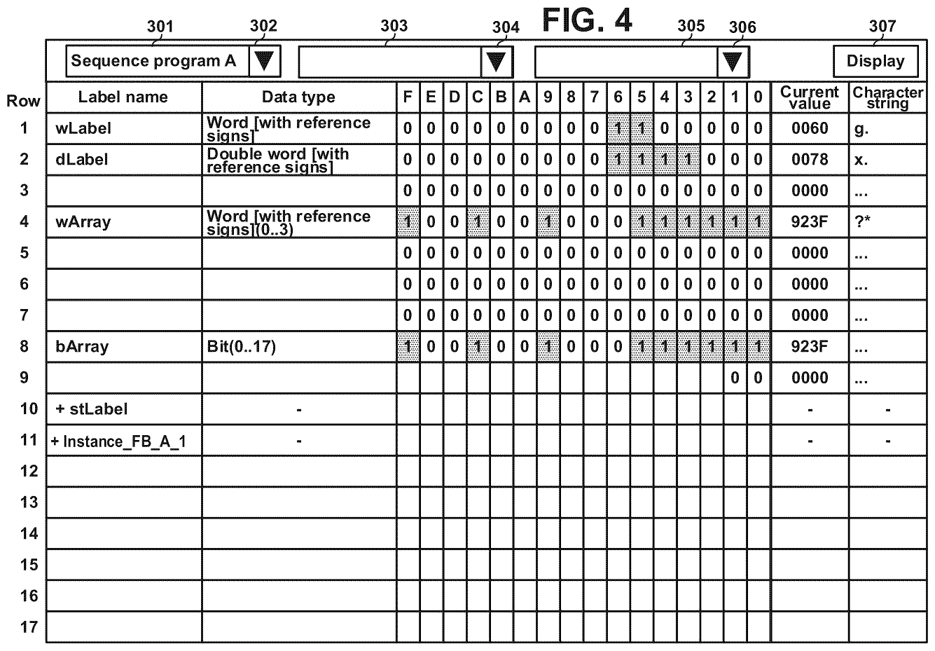

As illustrated in, for example, FIG. 4, the display 104 displays label data about the labels included in “the sequence program A” acquired by the acquirer 103. The display 104 displays, for example, bit strings for the label name “wLabel” with a bit width of 16 bits, “dLabel” with a bit width of 32 bits, “wArray” with a bit width of 16 bits, and “bArray” with a bit width of 18 bits. The bit string for the label name “bArray” with a bit width of 18 bits is wrapped as in the eighth and the ninth rows of the table in FIG. 4. The display 104 displays cells with the value 1 in bit strings in color.

The display 104 displays label names indicating a structure and an instance by adding symbol “+”. The display 104 displays, for example, label names “+stLabel” and “+Instance_FB_A_1” as in the tenth and the eleventh rows of the table in FIG. 4. When the user selects a label name with symbol “+”, the display 104 displays one or more labels included in the structure or the instance.

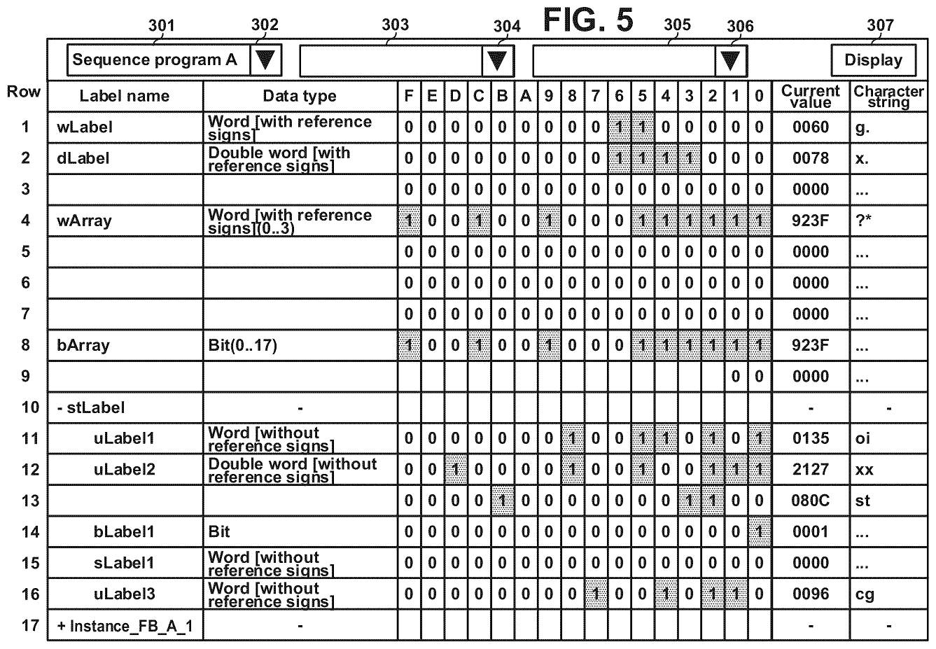

When, for example, the label name “+stLabel” in the tenth row of the table in FIG. 4 is selected, the display 104 displays labels included in the label name “+stLabel” in an expanded manner as in the tenth to the sixteenth rows of the table in FIG. 5.

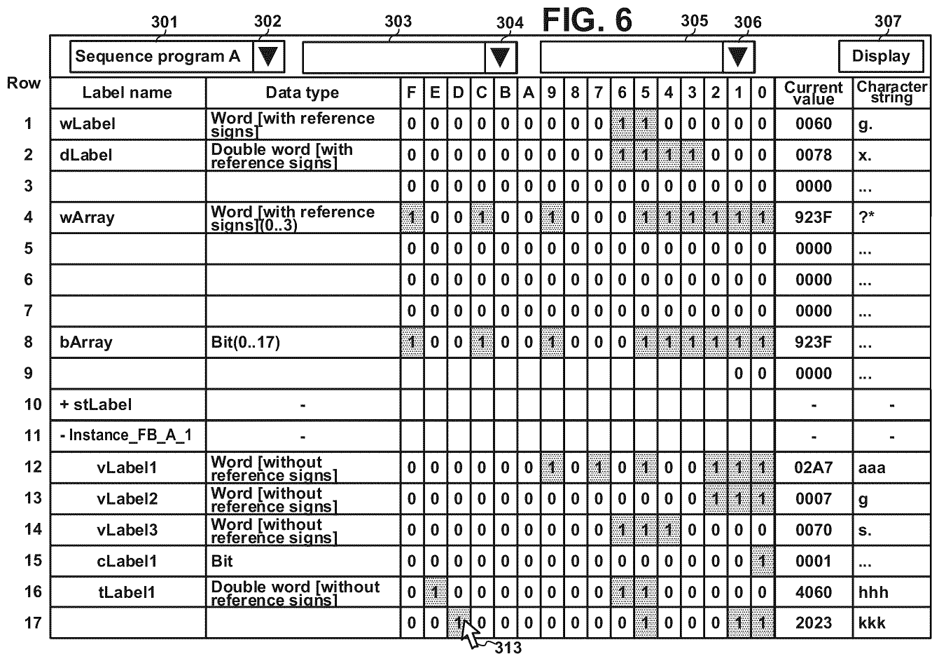

When, for example, the label name “+Instance_FB_A_1” in the eleventh row of the table in FIG. 4 is selected, the display 104 displays labels included in the label name “Instance_FB_A_1” in an expanded manner as in the eleventh to the seventeenth rows of the table in FIG. 6.

The filter processor 105 in FIG. 1 receives an input of a character string included in a name of the label and causes the display 104 to display, from among the plurality of labels with the values displayed by the display 104, a label including the received character string in the name of the label. The filter processor 105 is implemented by the processor 11 and the inputter 15. The filter processor 105 is an example of filter processing means.

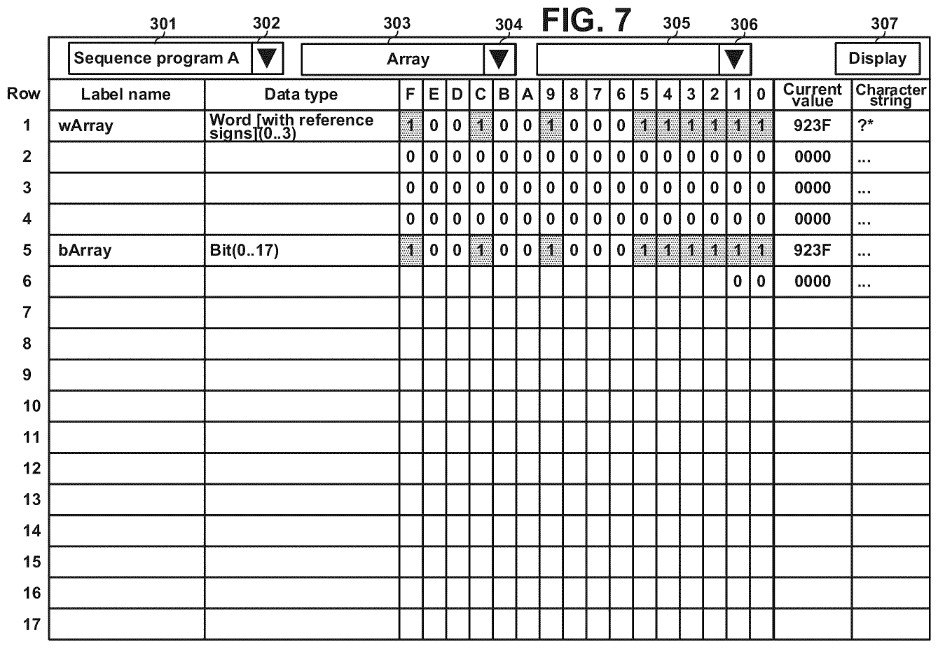

When, for example, the user inputs a character string “Array” into the field 303 in the label value display window and presses the display button 307, the filter processor 105 causes the display 104 to display the values of the labels for label names “wArray” and “bArray” including the character string “Array” as in the first to the sixth rows of the table in FIG. 7.

The changer 106 in FIG. 1 receives a change in values in bit strings displayed by the display 104 and causes the PLC 200 to execute, using data represented by the changed bit string, the sequence program identified with sequence program ID information. The changer 106 is implemented by the processor 11, the communicator 14, and the inputter 15. The changer 106 is an example of changing means.

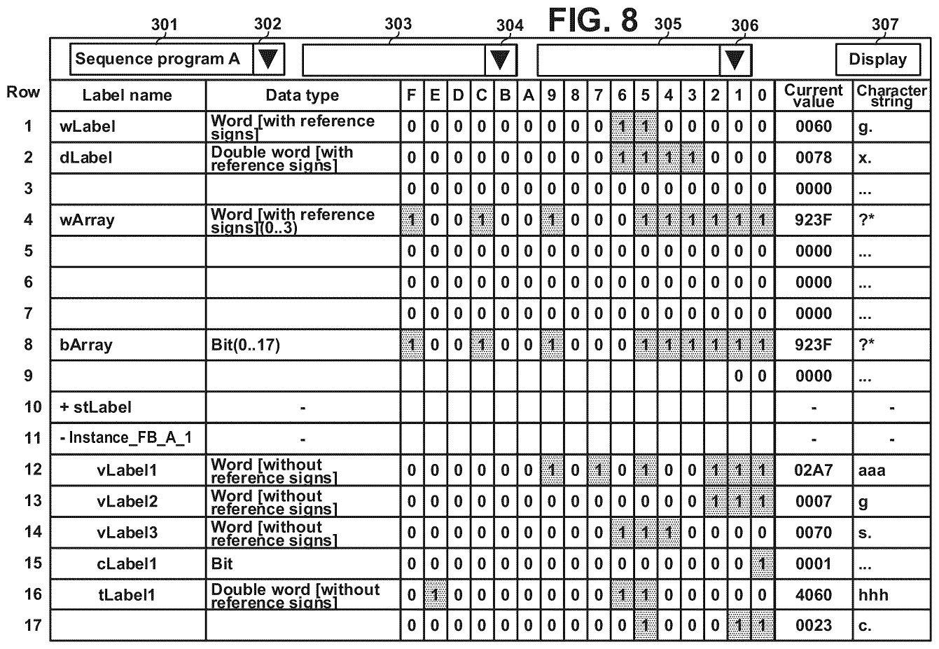

When the user double-clicks with a pointer 313 on the value corresponding to “D” in the bit string in the seventeenth row of the table as illustrated in FIG. 6, the changer 106 receives a change operation in the value corresponding to “D” in the bit string in the seventeenth row in the table to be changed from “1” to “0”. The changer 106 receives the change operation and causes the display 104 to display the changed bit string “0000000000100011” as in the seventeenth row of the table in FIG. 8. The changer 106 then requests the PLC 200 to execute, using data represented by the changed bit string, “the sequence program A”.

The acquirer 103 newly acquires, from the PLC 200 on which the sequence program identified with the sequence program ID information has been executed using the data represented by the changed bit string, the value of the label included in the sequence program identified with the sequence program ID information. The display 104 displays the newly acquired value of the label in a bit string with a bit width assigned to the label corresponding to the newly acquired value.

The PLC 200 executes, for example, using the changed bit string “0000000000100011”, “the sequence program A” and updates the values of the labels included in “the sequence program A” in the label data storage 201. The acquirer 103 acquires the updated values of the labels included in “the sequence program A” from the PLC 200. The display 104 displays the acquired values of the labels in the label value display window. When any value of a label, other than the value of the label changed by the user, has varied due to execution of the sequence program using the changed bit string, the value of the label changed by the user and the varied value of the label are displayed in the label value display window. When no values of the labels, other than the value of the label changed by the user, have varied, the value of the label changed by the user and the unvaried values of the labels are displayed in the label value display window. The table in FIG. 8 illustrates the changed value of the label with the label name “tLabel1” while other values of the labels remain unvaried.

The function block ID information receiver 107 in FIG. 1 receives an input of function block ID information for identifying a function block. The function block ID information receiver 107 is implemented by the processor 11 and the inputter 15. The function block ID information receiver 107 is an example of function block identification information receiving means.

The function block ID information is information used for identifying a function block used in a sequence program stored in the sequence program storage 101. The function block ID information is, for example, the name of a function block.

When the user inputs, for example, a function block name “FB_A” into the field 305 and presses the display button 307 in the label value display window, the function block ID information receiver 107 receives an input of function block ID information about “FB_A”.

The acquirer 103 acquires, from the PLC 200 on which the sequence program identified with the sequence program ID information has been executed, a value of a label included in an instance generated from the function block identified with the function block ID information. The display 104 displays the acquired value of the label.

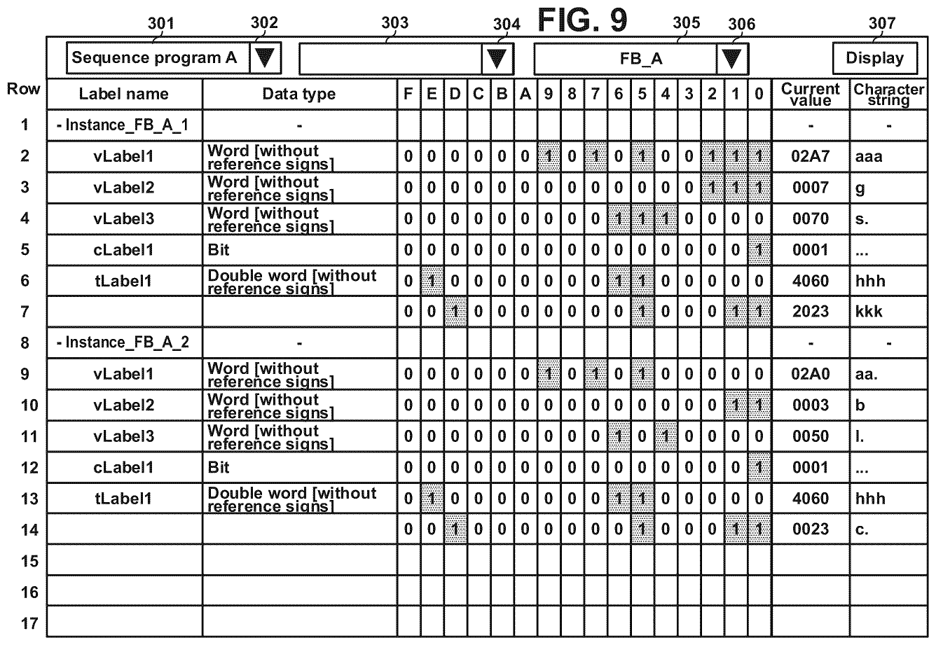

The acquirer 103 specifies, for example, instances generated from “FB_A” in the sequence programs stored in the sequence program storage 101. In other words, the acquirer 103 specifies an instance generated from “FB_A” in “the sequence program A” input as the sequence program ID information by the user as well as an instance generated from “FB_A” in other sequence programs. The acquirer 103 then acquires label data about the labels included in the specified instances from the PLC 200. The acquirer 103 may specify, for example, instances for label names “Instance_FB_A_1” and “Instance_FB_A_2” as the instances generated from “FB_A”. The instances for the label name “Instance_FB_A_2” are used in sequence programs other than “the sequence program A”. The acquirer 103 may acquire values of labels included in instances for the label names “Instance_FB_A_1” and “Instance_FB_A_2”. The display 104 displays the acquired values of the labels as illustrated in FIG. 9.

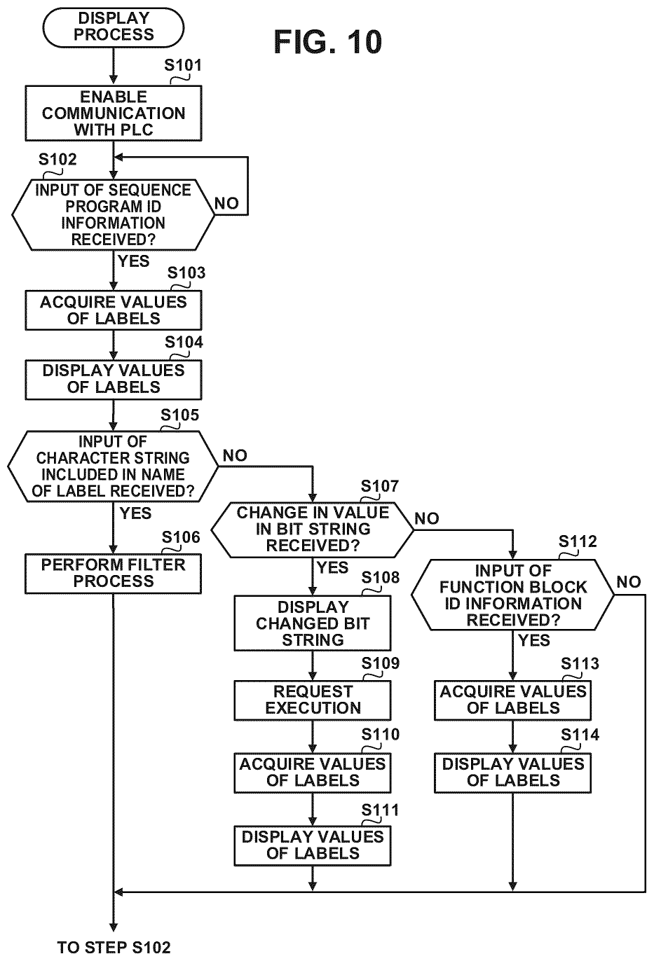

A display process performed by the debugging assistance device 100 according to the present embodiment is described with reference to the flowchart in FIG. 10. The display process in FIG. 10 is performed when, for example, the debugging assistance device 100 receives an operation for activating the label value display application from the user.

The acquirer 103 enables communication between the debugging assistance device 100 and the PLC 200 (step S101).

The sequence program ID information receiver 102 determines whether an input of sequence program ID information for identifying the sequence program is received (step S102). When the sequence program ID information receiver 102 determines that the input of the sequence program ID information is received (Yes in step S102), the acquirer 103 acquires, from the PLC 200 on which the sequence program identified with the sequence program ID information has been executed, a value of a label included in the sequence program identified with the sequence program ID information (step S103). When the sequence program ID information receiver 102 determines that no input of the sequence program ID information is received (No in step S102), the sequence program ID information receiver 102 continues to wait.

When, for example, the user inputs “the sequence program A” that is the name of the sequence program into the field 301 in the label value display window and presses the display button 307, the sequence program ID information receiver 102 determines that an input of the sequence program ID information about “the sequence program A” is received. The acquirer 103 then specifies the labels included in the “sequence program A” and acquires label data associated with the labels from the label data storage 201 in the PLC 200. When the user does not input the name of a sequence program into the field 301 in the label value display window or does not press the display button 307, the sequence program ID information receiver 102 determines that no input of the sequence program ID information is received and continues to wait.

The display 104 displays the acquired value of the label in a bit string with a bit width assigned to the label corresponding to the acquired value (step S104).

As illustrated in, for example, FIG. 4, the display 104 displays label data about the labels included in “the sequence program A” acquired by the acquirer 103.

The filter processor 105 then determines whether an input of a character string included in a name of the label is received (step S105). When the filter processor 105 determines that the input of the character string included in the name of the label is received (Yes in step S105), the filter processor 105 causes the display 104 to display, from among the plurality of labels with the values displayed by the display 104, a label including the received character string in the name of the label (step S106). The processing then returns to step S102. When the filter processor 105 determines that no input of the character string included in the name of the label is received (No in step S105), the processing advances to step S107.

When the user inputs, for example, a character string “Array” into the field 303 in the label value display window and presses the display button 307, the filter processor 105 determines that an input of the character string “Array” is received. The filter processor 105 then causes the display 104 to display the values of the labels for label names “wArray” and “bArray” as in the first to the sixth rows of the table in FIG. 7. When the user does not input a character string into the field 303 in the label value display window or does not press the display button 307, the filter processor 105 determines that no input of the character string is received. The processing then advances to step S107.

The changer 106 determines whether a change in values in bit strings displayed by the display 104 is received (step S107). When the changer 106 determines that the change in the values in the bit strings displayed by the display 104 is received (Yes in step S107), the changer 106 causes the display 104 to display the bit string with the changed values (step S108). The changer 106 then requests the PLC 200 to execute, using data represented by the changed bit string, the sequence program identified with the sequence program ID information (step S109).

When, for example, the user double-clicks with the pointer 313 on the value corresponding to “D” in the bit string in the seventeenth row of the table as illustrated in FIG. 6, the changer 106 determines that a change in the value corresponding to “D” in the bit string in the seventeenth row is received. The changer 106 causes the display 104 to display the changed bit string “0000000000100011” as in the seventeenth row of the table in FIG. 8. The changer 106 then requests the PLC 200 to execute, using data represented by the changed bit string, “the sequence program A”.

The acquirer 103 newly acquires, from the PLC 200 on which the sequence program identified with the sequence program ID information has been executed using data represented by the changed bit string, the value of the label included in the sequence program identified with sequence program ID information (step S110). The display 104 displays the newly acquired value of the label in a bit string with a bit width assigned to the label corresponding to the newly acquired value (step S111). The processing then returns to step S102. When the changer 106 determines that no change in the values in the bit string displayed by the display 104 is received (No in step S107), the processing advances to step S112.

For example, the acquirer 103 acquires, from the PLC 200, the values of the labels included in “the sequence program A” executed using the changed bit string “0000000000100011”. The display 104 displays the acquired values of the labels in the label value display window. When the user does not perform a change operation, the changer 106 determines that no change is received. The processing advances to step S112.

The function block ID information receiver 107 determines whether an input of function block ID information for identifying a function block is received (step S112). When the function block ID information receiver 107 determines that the input of the function block ID information is received (Yes in step S112), the acquirer 103 acquires, from the PLC 200 on which the sequence program identified with the sequence program ID information has been executed, a value of a label included in an instance generated from the function block identified with the function block ID information (step S113). The display 104 displays the acquired value of the label (step S114). The processing then returns to step S102. When the function block ID information receiver 107 determines that no input of the function block ID information is received (No in step S112), the processing returns to step S102.

When the user inputs, for example, a function block name “FB_A” into the field 305 in the label value display window and presses the display button 307, the function block ID information receiver 107 determines that an input of function block ID information about “FB_A” is received. The acquirer 103 specifies “Instance_FB_A_1” and “Instance_FB_A_2” as the instances generated from “FB_A” and acquires values of the labels included in these instances. The display 104 then displays the acquired values of the labels as illustrated in FIG. 9. When the user does not input the name of the function block into the field 305 in the label value display window or does not press the display button 307, the function block ID information receiver 107 determines that no input of the function block ID information is received. The processing then returns to step S102.

In the present embodiment, a value of a label included in a sequence program can be displayed in a bit string with a bit width assigned to the label. This allows the value of the label to be displayed in a bit string without the user specifying the bit width. Further, cells with the value “1” in a bit string are displayed in color to facilitate visual recognition of each bit that is on or off. When a plurality of labels are included in, for example, an instance generated from a structure or a function block, a bit string with a bit width assigned to each label can be viewed collectively. This can reduce man-hours for debugging.

In the present embodiment, a character string included in a label name is specified to selectively display the value of the label with the name including the character string. For a large-scale sequence program including numerous labels, the value of the intended label can be viewed easily.

In the present embodiment, when a bit string is changed, the values of the labels included in the sequence program executed using data represented by the changed bit string can be displayed. This facilitates viewing of changes in the value of other label following the change in the value of the label.

In the present embodiment, specifying a function block facilitates viewing of values of labels included in an instance generated from the function block and used in another sequence program.

### Modifications

The embodiments of the present disclosure described above may be modified or applied in various forms to implement the present disclosure.

The debugging assistance device 100 may eliminate some of the functions. The debugging assistance device 100 may not include, for example, the function block ID information receiver 107.

The label names may be displayed in different colors based on content of data assigned to each label. An instance may include, for example, labels associated with input data and labels associated with output data distinguished from each other by the color of the label name characters or label name fields. When, for example, label names “vLabel1”, “vLabel2”, and “vLabel3” are associated with input data, and label names “cLabel1” and “tLabel1” are associated with output data, the label names “vLabel1”, “vLabel2”, and “vLabel3” may be displayed in red, and the label names “cLabel1” and “tLabel1” may be displayed in blue in FIGS. 6 and 8. The labels associated with input data and the label associated with output data are thus distinguished easily from each other.

In the present embodiment described above, cells with the value “1” in bit strings are displayed in color. However, a display manner of values in bit strings displayed by the display 104 is not limited to that described above. The display 104 may display values in bit strings in any manner that facilitates visual recognition of each bit that is on or off. In other words, the display 104 changes the display mode of values in bit strings based on each value in the bit strings. The display 104 may display, for example, the value “1” in bit strings in bold or display cells with the value “1” in bit strings with shade. The display 104 may also combine these display modes, or specifically, display the value “1” in bit strings in bold and the cells with the value “1” with shade.

A display process performed by the debugging assistance device 100 is described in FIG. 10, but this is not limitative. In FIG. 10, for example, the processing in step S105 is followed by the processing in step S107 and step S112. However, the processing in step S107 may be followed by the processing in step S105 or step S112, or the processing in step S112 may be followed by the processing in step S105 or step S107 instead.

An operating program to define the operation of the debugging assistance device 100 according to the embodiment described above may be executed on an existing personal computer or an information terminal device to cause the personal computer or the information terminal device to function as the debugging assistance device 100 according to the embodiment.

The above program may be distributed with any method. For example, the program may be stored in a non-transitory computer-readable recording medium such as a compact disk read-only memory (CD-ROM), a digital versatile disk (DVD), or a memory card for distribution or may be distributed through a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The debugging assistance program, the debugging assistance device, and the debugging assistance method according to the above embodiment of the present disclosure can display a value of a label in a sequence program in a bit string with a bit width assigned to the label.

### REFERENCE SIGNS LIST

11 Processor
12 Main storage
13 Auxiliary storage
14 Communicator
15 Inputter
16 Outputter
17 Real time clock (RTC)
18 Bus
100 Debugging assistance device
101 Sequence program storage
102 Sequence program identification (ID) information receiver
103 Acquirer
104 Display
105 Filter processor
106 Changer
107 Function block identification (ID) information receiver
200 Programmable logic controller (PLC)
201 Label data storage
301, 303, 305 Field
302, 304, 306 Pulldown button
307 Display button
308 to 312 Item
313 Pointer

1. A non-transitory computer-readable recording medium storing a debugging assistance program, the debugging assistance program causing a computer to execute processing comprising:
acquiring, from a programmable logic controller on which a sequence program identified with sequence program identification information for identifying the sequence program has been executed, a value of a label included in the sequence program identified with the sequence program identification information; and
displaying the acquired value of the label in a bit string with a bit width assigned to the label corresponding to the acquired value.

2. The non-transitory computer-readable recording medium according to claim 1, wherein
the sequence program identified with the sequence program identification information includes a plurality of labels, and
the debugging assistance program causes the computer to execute processing further comprising
acquiring values of the plurality of labels included in the sequence program identified with the sequence program identification information, and
displaying each of the acquired values of the plurality of labels in a bit string with a bit width assigned to each of the plurality of labels corresponding to the acquired values.

3. The non-transitory computer-readable recording medium according to claim 2, wherein
the plurality of labels include a label included in an instance generated from a function block or a label included in a structure.

4. The non-transitory computer-readable recording medium according to claim 2, wherein
the debugging assistance program causes the computer to execute processing further comprising
receiving an input of a character string included in a name of the label and displaying, from among the plurality of labels with the displayed values, a label including the received character string in the name of the label.

5. The non-transitory computer-readable recording medium according to claim 1, wherein
the debugging assistance program causes the computer to execute processing further comprising
receiving an input of the sequence program identification information,
receiving an input of function block identification information for identifying a function block, and
acquiring, from the programmable logic controller on which the sequence program identified with the sequence program identification information has been executed, a value of a label included in an instance generated from the function block identified with the function block identification information.

6. The non-transitory computer-readable recording medium according to claim 1, wherein
the debugging assistance program causes the computer to execute processing further comprising
receiving a change in the displayed value in the bit string and causing the programmable logic controller to execute, using data represented by the changed bit string, the sequence program identified with the sequence program identification information,
newly acquiring, from the programmable logic controller on which the sequence program identified with the sequence program identification information has been executed using the data represented by the changed bit string, the value of the label included in the sequence program identified with the sequence program identification information, and
displaying the newly acquired value of the label in a bit string with a bit width assigned to the label corresponding to the newly acquired value.

7. The non-transitory computer-readable recording medium according to claim 1, wherein
the debugging assistance program causes the computer to execute processing further comprising
changing, based on the value in the bit string, a display mode of the value in the bit string.

8. A debugging assistance device, comprising:
processing circuitry; and
a storage,
the processing circuitry being configured to
acquire, from a programmable logic controller on which a sequence program identified with sequence program identification information for identifying the sequence program has been executed, a value of a label included in the sequence program identified with the sequence program identification information; and
display the acquired value of the label in a bit string with a bit width assigned to the label corresponding to the acquired value.

9. A debugging assistance method, comprising:
acquiring, from a programmable logic controller on which a sequence program identified with sequence program identification information for identifying the sequence program has been executed, a value of a label included in the sequence program identified with the sequence program identification information; and
displaying, the acquired value of the label in a bit string with a bit width assigned to the label corresponding to with the acquired value.

10. The non-transitory computer-readable recording medium according to claim 3, wherein
the debugging assistance program causes the computer to execute processing further comprising
receiving an input of a character string included in a name of the label and displaying, from among the plurality of labels with the displayed values, a label including the received character string in the name of the label.

11. The non-transitory computer-readable recording medium according to claim 2, wherein
the debugging assistance program causes the computer to execute processing further comprising
receiving an input of the sequence program identification information,
receiving an input of function block identification information for identifying a function block, and
acquiring, from the programmable logic controller on which the sequence program identified with the sequence program identification information has been executed, a value of a label included in an instance generated from the function block identified with the function block identification information.

12. The non-transitory computer-readable recording medium according to claim 3, wherein
the debugging assistance program causes the computer to execute processing further comprising
receiving an input of the sequence program identification information,
receiving an input of function block identification information for identifying a function block, and
acquiring, from the programmable logic controller on which the sequence program identified with the sequence program identification information has been executed, a value of a label included in an instance generated from the function block identified with the function block identification information.

13. The non-transitory computer-readable recording medium according to claim 4, wherein
the debugging assistance program causes the computer to execute processing further comprising
receiving an input of the sequence program identification information,
receiving an input of function block identification information for identifying a function block, and
acquiring, from the programmable logic controller on which the sequence program identified with the sequence program identification information has been executed, a value of a label included in an instance generated from the function block identified with the function block identification information.

14. The non-transitory computer-readable recording medium according to claim 2, wherein
the debugging assistance program causes the computer to execute processing further comprising
receiving a change in the displayed value in the bit string and causing the programmable logic controller to execute, using data represented by the changed bit string, the sequence program identified with the sequence program identification information,
newly acquiring, from the programmable logic controller on which the sequence program identified with the sequence program identification information has been executed using the data represented by the changed bit string, the value of the label included in the sequence program identified with the sequence program identification information, and
displaying the newly acquired value of the label in a bit string with a bit width assigned to the label corresponding to the newly acquired value.

15. The non-transitory computer-readable recording medium according to claim 3, wherein
the debugging assistance program causes the computer to execute processing further comprising
receiving a change in the displayed value in the bit string and causing the programmable logic controller to execute, using data represented by the changed bit string, the sequence program identified with the sequence program identification information,
newly acquiring, from the programmable logic controller on which the sequence program identified with the sequence program identification information has been executed using the data represented by the changed bit string, the value of the label included in the sequence program identified with the sequence program identification information, and
displaying the newly acquired value of the label in a bit string with a bit width assigned to the label corresponding to the newly acquired value.

16. The non-transitory computer-readable recording medium according to claim 4, wherein
the debugging assistance program causes the computer to execute processing further comprising
receiving a change in the displayed value in the bit string and causing the programmable logic controller to execute, using data represented by the changed bit string, the sequence program identified with the sequence program identification information,
newly acquiring, from the programmable logic controller on which the sequence program identified with the sequence program identification information has been executed using the data represented by the changed bit string, the value of the label included in the sequence program identified with the sequence program identification information, and
displaying the newly acquired value of the label in a bit string with a bit width assigned to the label corresponding to the newly acquired value.

17. The non-transitory computer-readable recording medium according to claim 5, wherein
the debugging assistance program causes the computer to execute processing further comprising
receiving a change in the displayed value in the bit string and causing the programmable logic controller to execute, using data represented by the changed bit string, the sequence program identified with the sequence program identification information,
newly acquiring, from the programmable logic controller on which the sequence program identified with the sequence program identification information has been executed using the data represented by the changed bit string, the value of the label included in the sequence program identified with the sequence program identification information, and
displaying the newly acquired value of the label in a bit string with a bit width assigned to the label corresponding to the newly acquired value.

18. The non-transitory computer-readable recording medium according to claim 2, wherein
the debugging assistance program causes the computer to execute processing further comprising
changing, based on the value in the bit string, a display mode of the value in the bit string.

19. The non-transitory computer-readable recording medium according to claim 3, wherein
the debugging assistance program causes the computer to execute processing further comprising
changing, based on the value in the bit string, a display mode of the value in the bit string.

20. The non-transitory computer-readable recording medium according to claim 4, wherein
the debugging assistance program causes the computer to execute processing further comprising
changing, based on the value in the bit string, a display mode of the value in the bit string.
